(19) United States
(12) Patent Application Publication
(10) Pub. No.: US 2015/0210460 A1
(43) Pub. Date: Jul. 30, 2015

(54) OZONE UNIT FOR A SHIPPING CONTAINER

(71) Applicant: OA-GLOBAL IP LIMITED, Hamilton (NZ)

(72) Inventor: Robert Logan Cherry, Papamoa (NZ)

(21) Appl. No.: 14/421,685

(22) PCT Filed: Aug. 15, 2013
(86) PCT No.: PCT/NZ2013/000143

§ 371 Date: Feb. 13, 2015

(30) Foreign Application Priority Data
Aug. 15, 2012 (NZ) 601839

(51) Int. Cl. B65D 81/24; B65D 88/74; C01B 13/11

(52) U.S. Cl. CPC B65D 81/24; C01B 13/11; B65D 88/74

(57) ABSTRACT

The invention relates to an ozone unit for a shipping container configured to be easily retrofitted to or integrated in a shipping container.

### CROSS-REFERENCE TO RELATED APPLICATION

This application claims priority from New Zealand complete patent application No. 601839, filed on 15 Aug. 2012, the content of which is incorporated by reference herein in its entirety.

### TECHNICAL FIELD

The invention relates to an ozone unit for a shipping container. More particularly but not exclusively, it relates to an ozone unit configured and adapted to be easily retrofitted to or integrated in a shipping container.

### BACKGROUND OF THE INVENTION

Refrigerated shipping containers are used to maintain the freshness of perishable food produce such as fruit and vegetables during long distance shipping.

It is known to introduce ozone into the circulating atmosphere within a refrigerated shipping container, to reduce or slow deterioration of produce in the container. Ozone adversely affects microorganisms which cause deterioration in produce and/or oxidises ethylene which is generated by ripening fruits and vegetables and in turn adversely affects the produce.

International patent application WO2009/070323 discloses a distributed ozonation system for storage rooms involving multiple ozonated areas such as shipping containers.

It is an object of the invention to provide an improved ozone unit for a shipping container or to at least provide the public with a useful choice.

### SUMMARY OF THE INVENTION

In broad terms in one aspect the invention comprises an ozone unit for a shipping container, comprising as an integrated unit an ozone generator, an ozone sensor or an input port for a signal from an ozone sensor, and a controller or a port for connection of a controller, and shaped and sized to be mounted at least partly within, or through, a pre-existing opening through an insulated wall of a standard insulated shipping container after removal of a pre-existing insulated cover and so as to enable replacement of the insulated cover within the opening after installation of the ozone unit.

Preferably the ozone unit is shaped and sized to be mounted securely in place by replacement of the insulated cover within the opening after installation of the ozone unit.

Preferably the ozone unit comprises a fixing portion allowing the unit to be mechanically fixed into place.

In one embodiment, the ozone unit is adapted to be fixed to the inside surface of the pre-existing insulated cover. In another embodiment, the ozone unit is adapted to be fixed internally in the pre-existing opening.

Preferably the ozone unit has a width and a height in a plane of the pre-existing opening in the wall of the container, a depth through the pre-existing opening, and wherein both the width and height of the unit is at least three times, or five times, or seven times greater than its depth.

In one embodiment the ozone unit comprises a common casing which houses the ozone generator, ozone sensor or an input port for a signal from an ozone sensor, and controller or the port for connection of the controller.

Preferably the input port for a signal from the ozone sensor is in a wall of the common casing.

Preferably the port for connection of the controller is in a wall of the common casing.

Preferably the common casing comprises a generally flat side for positioning against or adjacent an inside face of the insulated cover after installation.

Preferably the common casing is formed of a plastics material.

Preferably the casing comprises an opening for entry of air from within the container into the ozone unit and an opening for exit of ozone from the ozone unit. In one embodiment, the opening for entry of air is located near a top portion of the ozone unit and the opening for exit of ozone is located near a bottom portion of the ozone unit.

Preferably the ozone unit comprises a power lead for connecting to an external power supply. Alternatively the ozone unit comprises an internal power supply.

In broad terms in a second aspect the invention consists in an insulated shipping container comprising an interior, air circulating means for circulating an atmosphere within the shipping container, an opening through an insula+ted wall of the shipping container from the exterior to the interior thereof, and an ozone unit according to the first aspect of the invention and configured and adapted to be mounted in and/or through the opening, and an insulated cover for the opening.

Preferably the ozone unit is supported in place in part by on one side of the ozone unit replacement of the insulated cover within the opening.

Preferably the ozone unit is also supported in place by contact of another side of the ozone unit with a pre-existing internal structure of and within the shipping container.

Preferably the pre-existing internal structure of and within the shipping container is a fan unit which in operation circulates air in the shipping container.

Preferably the pre-existing internal structure of and within the shipping container comprises one or more brackets.

Preferably the ozone unit is held in place without requiring mechanical fixing tools to install.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features prefaced by that term in each statement all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 shows a perspective view of a shipping container with a cover temporarily removed from an opening;

FIG. 2A shows a perspective view of the shipping container of FIG. 1, also showing an ozone unit of the invention;

FIG. 2B shows an enlarged view of a part of a shipping container, also showing an ozone unit according to one embodiment of the invention mounted in an opening;

FIGS. 3A and 3B show a back and a front perspective view of one embodiment of an ozone unit;

FIGS. 4 and 5 are schematic views of the interior of the shipping container from a side—FIG. 4, and at one end—FIG. 5, showing the refrigeration system and an ozone unit within the shipping container, and the circulating atmosphere within the shipping container into which ozone is introduced;

FIG. 6 is a block schematic view of the internal parts of the ozone unit of FIGS. 3A and 3B, and

FIGS. 7A and 7B show a back and a front perspective view of another embodiment of an ozone unit.

### DETAILED DESCRIPTION OF PREFERRED EMBODIMENTS

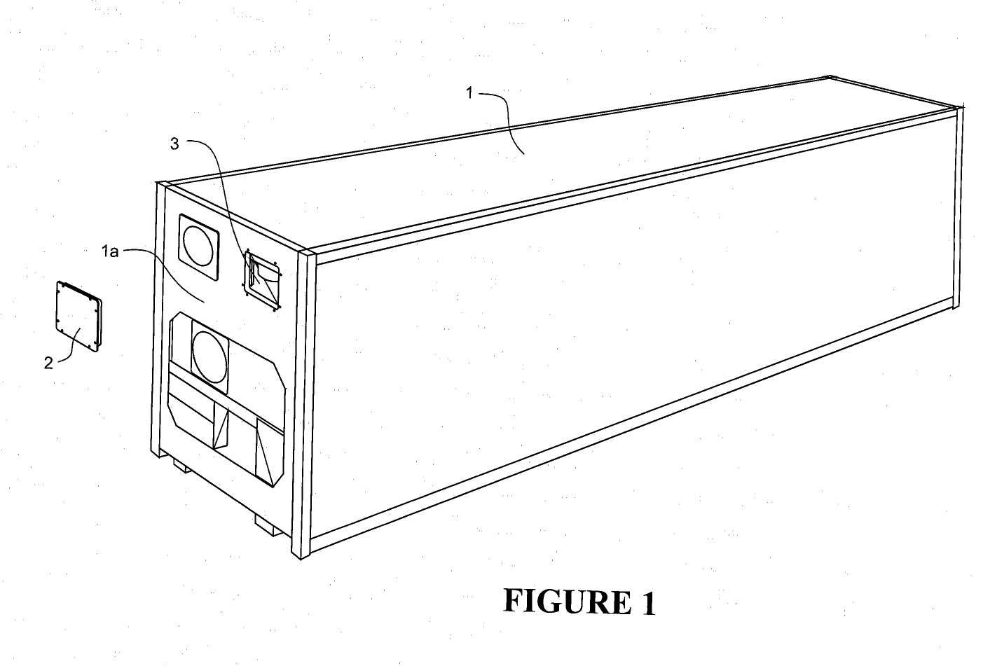

FIG. 1 shows a perspective view of a standard refrigeration shipping container 1, which has a cover or plug 2 temporarily removed from a pre-existing opening 3. The opening 3 may be a fan access opening, typically in an end wall 1a of the container, through the container wall from the exterior to the interior of the container, adjacent to the refrigeration system within the container and past which air circulating within the container moves when the refrigeration system is operating. The container is an insulated container and typically the container walls comprise thermal insulation between metal cladding, so that the opening through the wall has thickness. The cover or plug 2 is also insulated i.e. also comprises thermal insulation.

In accordance with the invention the ozone unit 5 is mounted at least partly within or through the opening 3 so as to enable replacement of the pre-existing insulated cover or plug 2 within the opening 3 after installation of the ozone unit 5.

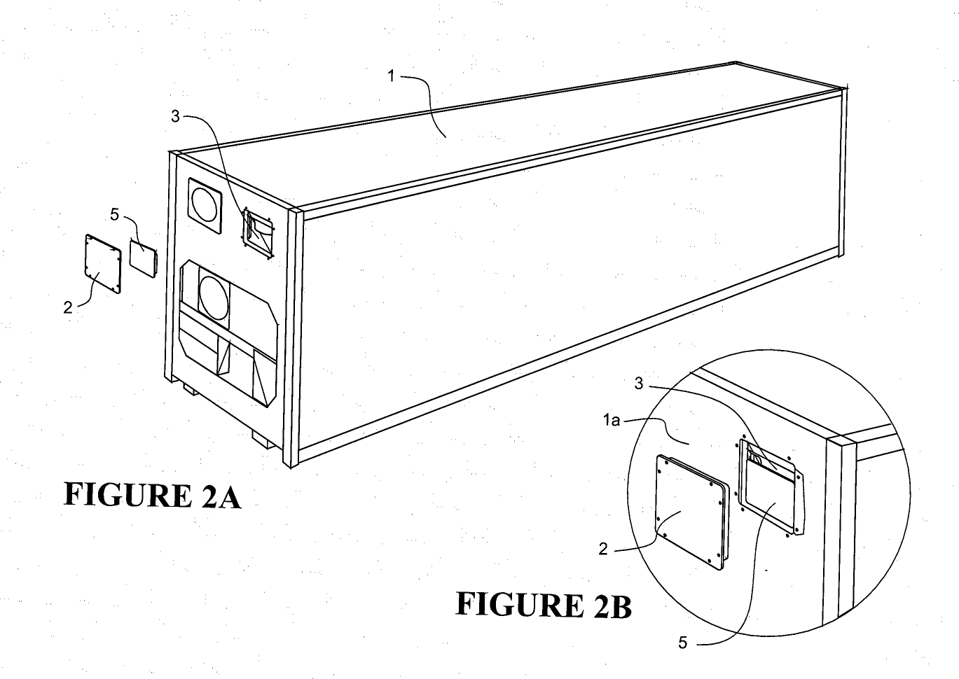

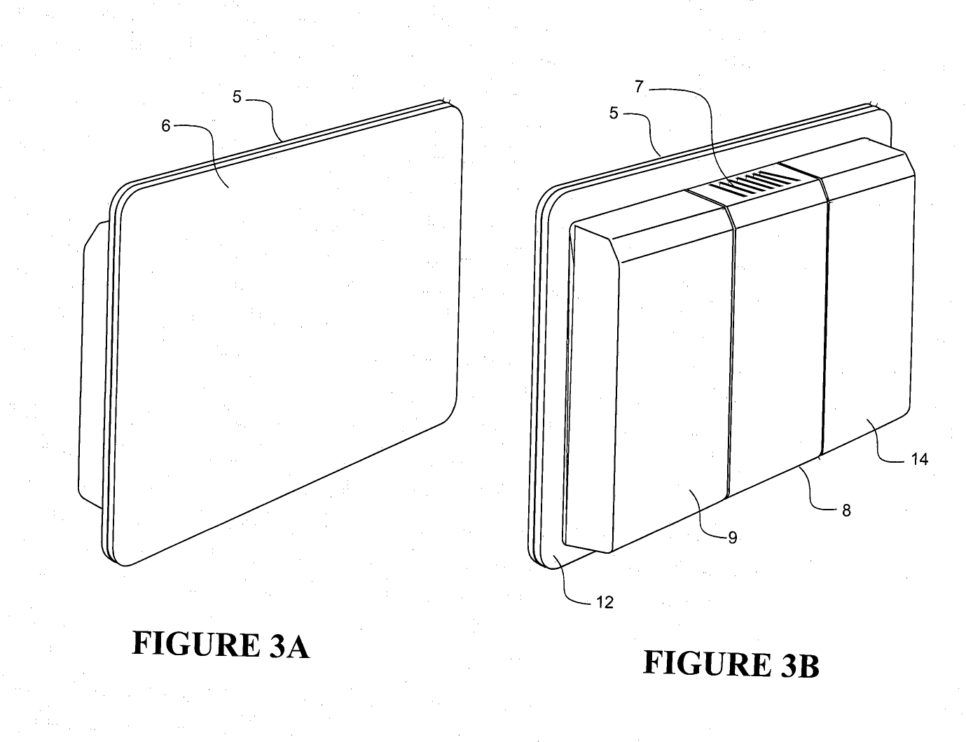

FIGS. 2A and 2B show such a shipping container and also an ozone unit 5 according to the invention. The ozone unit 5 is installed into the opening 3, after removing the insulated cover 2, and the cover 2 is then re-installed (after the ozone unit is fitted). Further, re-installation of the cover 2 may fix or assist in fixing the ozone unit 3 in place. Advantageously in accordance with the invention, because the pre-existing cover 2 is re-installed it remains with the container 3 and will not be lost. The container 1 can also maintain its insulation after re-installation of the insulated cover or plug 2.

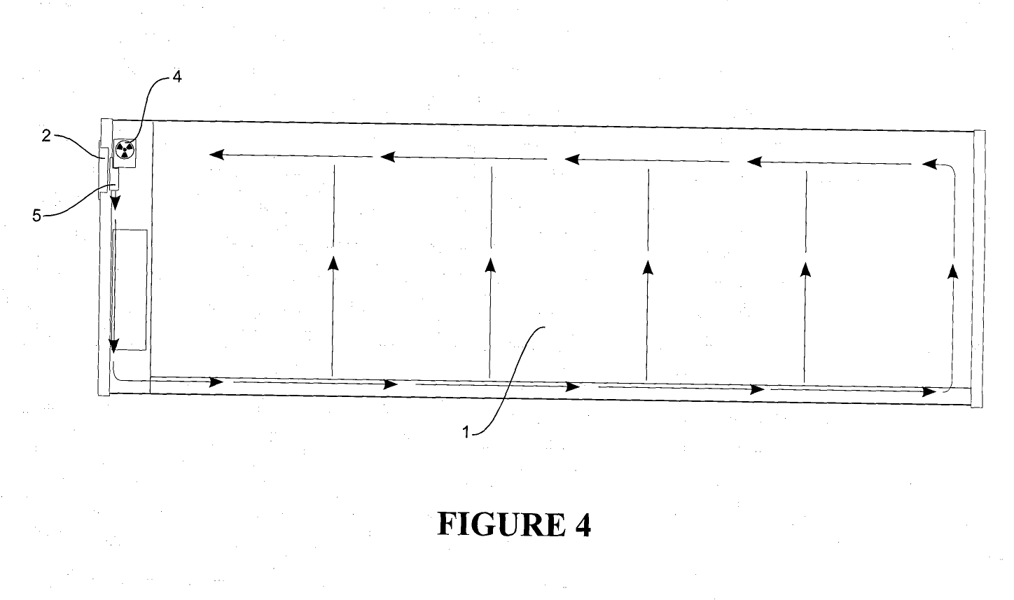

FIGS. 3A and 3B show perspective back and front views of one embodiment of the ozone unit respectively. Rear side 6 of the ozone unit 5 shown in FIG. 3A sits against or adjacent the inside face of the cover 2 after installation. Front side 14 shown in FIG. 3B may sit against/above the standard circulation fan unit 4 in many refrigeration shipping containers. As shown the rear side 6 comprises a substantially flat surface. Preferably the opposite side also comprises a substantially flat surface.

In particular, the rear side 6 of the ozone unit may abut brackets depending downwardly from the bottom of the fan unit or in the mounting shelf or bracket for the fan unit, towards the inside surface of the container wall, to which the brackets and fan units supported are fixed, over or adjacent the opening 3 in the container wall, and/or an upper part of the front or side ozone unit 5 may abut a lower part of the back or rear surface of the fan unit 4. Thus, when the cover or plug 2 is reinstalled after the ozone unit 5 has been installed in the opening 3 in this position, in this embodiment the ozone unit 5 is held in place without requiring screwing or bolting or fixing or other semi-permanent fixing typically requiring tools.

In alternative embodiments the front of the ozone unit may abut some part of the refrigeration or system adjacent the opening 3 inside the container, other than these brackets.

In other embodiments again, the ozone unit may be screwed or bolted or similarly fixed in place, whilst still allowing for reinstallation of the cover or plug 2 into the opening 3 after the installation of the ozone unit 5. In the embodiment of FIGS. 3A and 3B the ozone unit 5 comprises a fixing portion in the form of a peripheral flange 12 extending transversely outwardly from the rear side 6. The flange 12 may comprise preformed holes or apertures allowing the unit to be screwed or bolted into place. In one embodiment, the ozone unit 5 is to be mounted internally of the pre-existing opening 3, after which the cover 2 is then re-installed. In another embodiment, the ozone unit 5 is to be fixed to the inside surface of the cover 2, and then the cover 2 is re-installed.

Referring to FIGS. 3A and 3B, in this embodiment the ozone unit 5 has a relatively larger width and a height in a plane of the pre-existing opening 3 in the wall of the container and a smaller depth through the pre-existing opening. The ozone unit 5 comprises a substantially rectangular or square shape in front or rear view. In the embodiment shown the width of the ozone unit 5 is slightly larger than its height. Preferably both the width and height of the ozone unit 5 are much greater than the depth of the unit so that the ozone unit 5 is a thin and flat panel. Both the width and height of the unit 5 may be at least three times or at least five times or at least seven times larger than the depth of the unit.

The width and height of the ozone unit 5 is smaller than the width and height of the opening 3 so that the unit may be installed in the opening. In one embodiment, the depth of the ozone unit 5 is greater than the depth of the opening 3 so that after installation a part of the front part of the ozone unit 5 projects past the inside surface of the container wall into the interior of the container. In another embodiment, the depth of the ozone unit 5 is not greater than the depth of the opening, but the opening for air entry and opening for ozone exit are still arranged to project past the inside surface of the container into the interior of the container. This is so that the ozone generator is provided with sufficient air supply and the ozone produced is more easily mixed with the circulating atmosphere within the shipping container.

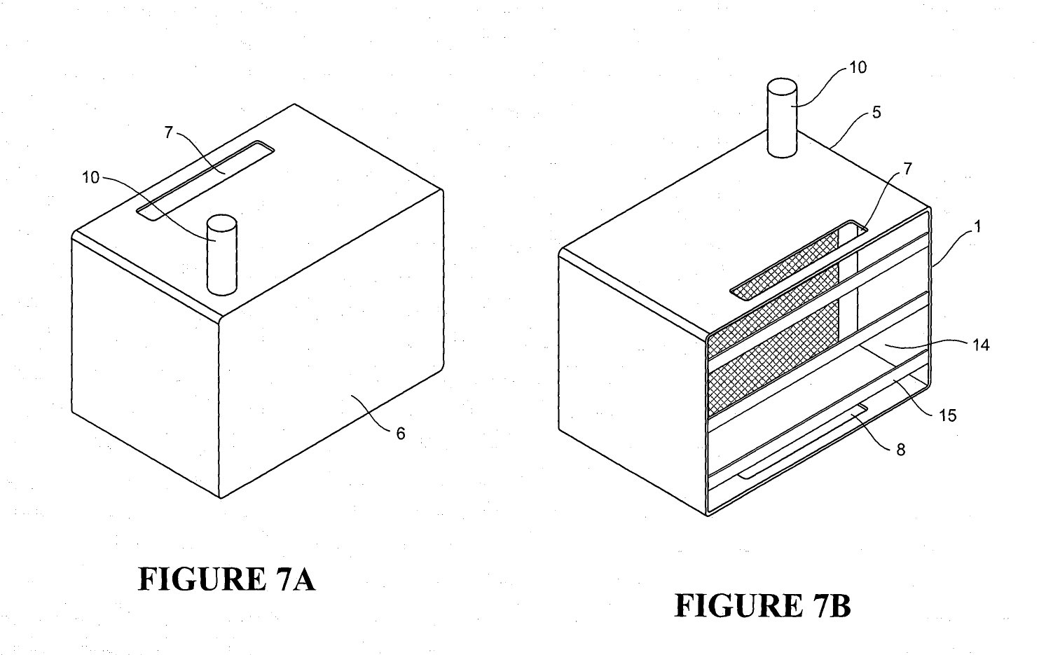

The shape and design of an ozone unit 5 can be different from that shown in FIGS. 3A and 3B so long as it still allows re-installation of the cover 2 after the ozone unit 5 is fitted. FIGS. 7A and 7B shows perspective rear and front views of another embodiment of the ozone unit 5. The unit still has a width slightly larger than its height and a substantially rectangular or square shape in plan view. However in this embodiment its depth is larger than in the embodiment of FIGS. 3A and 3B. The unit 5 again comprises an air inlet 7 near a top portion of the unit 5, and an ozone outlet 8 near a bottom portion of the unit 5. The unit 5 can be mounted on the inside surface of the cover 2. It may be bolted or screwed into place, or the cover 2 may comprise a supporting bracket on its inside surface allowing the unit 5 to directly sit on top of the bracket.

In the embodiments shown all of the ozone unit components are mounted within a common casing as shown in FIGS. 3A and 3B, and FIGS. 7A and 7B, which may be formed of a moulded or thermoformed plastic material for example.

In the embodiment of FIGS. 7A and 7B the common casing may also comprise protective plates 15 on a front side surface 14 of the ozone unit 5 for protecting the components housed inside the casing.

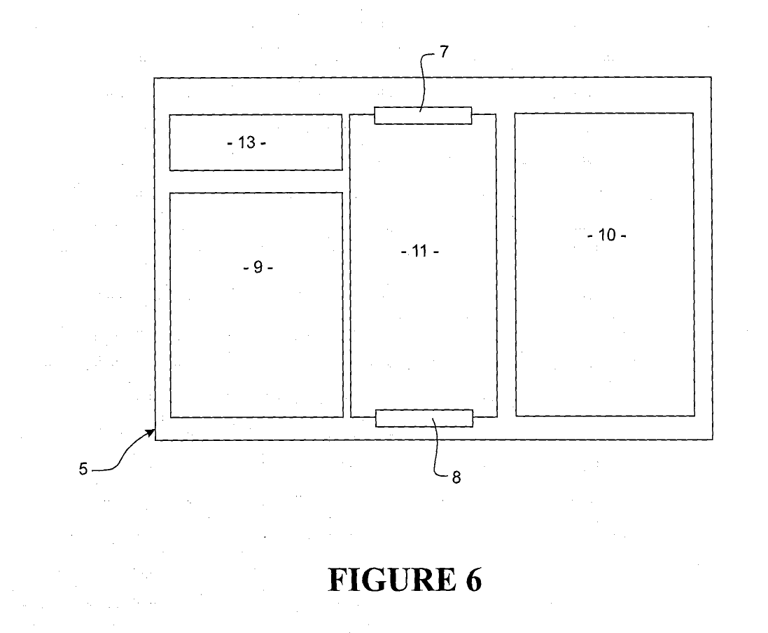

FIG. 6 is a block schematic view of the internal parts of the ozone unit of FIGS. 3A and 3B. These are an ozone sensor 10 for measuring the ozone level within the shipping container, or alternatively at least an input port for receiving a signal from a remotely located ozone sensor, an ozone generator 11, and a controller 9 or a connection port for the controller 9 which controls the ozone generator to maintain a predetermined ozone level in the atmosphere in the container. The same parts and/or ports may be provided in the casing of the embodiment of FIGS. 7A and 7B.

The controller 9 may allow a user to select and adjust an ozone concentration setting, through a control panel on the exterior common casing of the ozone unit 5 or wirelessly for example. The controller 9 can be located in the common casing or alternatively it can be located outside of the common casing in which case the common casing provides a port for connection for the controller on a wall of the casing. The controller 9 can be installed in the same pre-existing opening with the common casing and is operatively connected to the ozone unit 5 via the controller connection port. Or alternatively the controller 9 can be remotely located in a different pre-existing opening or at another user preferred location.

The controller 9 may indicate to a user whether the ozone unit 5 and/or a circulating fan within the shipping container is/are operating properly. It may alarm a user when a system fault occurs for example when the concentration of ozone falls below or exceeds a desired level by generating a visual or an audio alarm.

In another embodiment the ozone sensor 10 is not mounted within the common casing and may be mounted on the return air side or air intake side of an air circulating fan 4 in the shipping container, so as to more accurately measure the ozone concentration in the shipping container. The sensor output is then fed to the input port which is placed in or on a wall of the common casing of the ozone unit 5.

Alternatively in another embodiment, the ozone sensor 10 is removably attached to a wall of the common casing as shown in FIGS. 7A and 7B. This allows the sensor 10 to be easily replaced when required.

The ozone unit 5 may have a power lead extending from an end of the ozone unit which is manually connectable to a power supply accessible from within the opening 3. Alternatively, the power lead may comprise a plug allowing a user to directly plug into a power socket. Or alternatively the ozone unit may comprise a built-in power source such as a battery 13 housed in the common casing.

In one preferred embodiment, the ozone generator 11 is a corona discharge ozone generator within the ozone unit 5. In use air (or alternatively oxygen from a supply) passes the corona after entering the ozone unit via grille 7 near a top portion of the ozone unit 5 (oxygen molecules are temporarily separated into individual oxygen atoms which recombine to oxygen and ozone). Ozone exits a grille near a bottom portion of the ozone unit 5 (not shown) for example on the underside of the ozone unit 5, indicated at 8. However other types of ozone generator may be used within the ozone unit 5. In use circulation fan 3 circulates the atmosphere within the shipping container and the circulating air flow passes the ozone unit and ozone generated by the ozone unit mixes into the air flow.

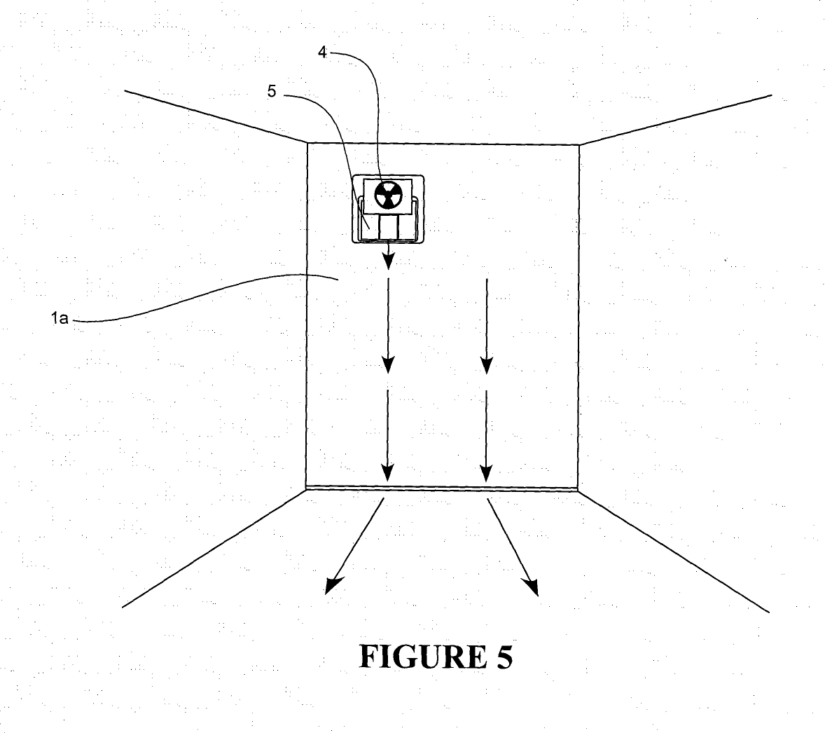

FIGS. 4 and 5 are schematic views of the interior of the shipping container from a side—FIG. 4, and at one end—FIG. 5, showing the refrigeration system and the ozone within the shipping container, and the circulating atmosphere within the shipping container into which ozone is introduced. In the example shown, the opening 3 is a fan access opening. The arrows in FIGS. 4 and 5 indicate the air flow path within the container.

The invention preferred embodiment has been described by way of example and it is to be understood that modifications and/or improvements may be made without departing from the scope or spirit of the invention as defined in the claims.

1. An ozone unit for a shipping container, comprising as an integrated unit an ozone generator, an ozone sensor or an input port for a signal from an ozone sensor, and a controller or a port for connection of a controller, and shaped and sized to be mounted partly at least within, or through, a pre-existing opening through an insulated wall of a standard insulated shipping container alter removal of a pre-existing insulated cover and so as to enable replacement of the insulated cover within the opening after installation of the ozone unit.

2. An ozone unit according to claim 1 shaped and sized to be mounted securely in place by replacement of the insulated cover within the opening after installation of the ozone unit,

3. An ozone unit either according to claim 1 comprising a fixing portion allowing the unit to be mechanically fixed into place.

4. An ozone unit according to claim 3 adapted to be fixed to the inside surface of the pre-existing insulated cover.

5. An ozone unit according to claim 3 adapted to be fixed internally in the pre-existing opening.

6. An ozone unit according to claim 1 having a width and a height in a plane of the pre-existing opening in the wall of the container, a depth through the pre-existing opening, and wherein both the width and height of the unit is at least three times greater than its depth.

7. An ozone unit according to claim 1 having a width and a height in a plane of the pre-existing opening in the wall of the container, a depth through the pre-existing opening. wherein both the width and height of the unit is at least five times larger than its depth.

8. An ozone unit according to claim 1 having a width and a height in a plane of the pre-existing opening in the wall of the container, and a depth through the pre-existing opening, wherein both the width and height of the unit is at least seven times larger than its depth.

9. An ozone unit according to claim 1 comprising a common casing which houses the ozone generator, controller or the port for connection of the controller, and the ozone sensor or the input port for a signal from the ozone sensor.

10. An ozone unit according to claim 9 wherein the input port for a signal from the ozone sensor is in a wall of the common casing.

11. An ozone unit according to claim 9 wherein the port for connection of the controller is in a wall of the common casing.

12. An ozone unit according to claim 9 wherein the common casing comprises a generally flat side for positioning against or adjacent an inside face of the insulated cover after installation.

13. (canceled)

14. An ozone unit according to claim 9 comprising in a casing of the ozone unit an opening for entry of air from within the container into the ozone unit and an opening for exit of ozone from the ozone unit.

15. An ozone unit according to claim 14 wherein the opening for entry of air is located near a top portion of the ozone unit and the opening for exit of ozone is located near a bottom portion of the ozone unit.

16. (canceled)

17. (canceled)

18. An insulated shipping container comprising an interior, air circulating means for circulating an atmosphere within the shipping container, an opening through an insulated wall of the shipping container from the exterior to the interior thereof, an ozone unit according to claim 1 mounted in and/or through the opening, and an insulated cover for the opening in place over the opening.

19. An insulated shipping container according to claim 18 wherein the ozone unit is supported in place in part by on one side of the ozone unit replacement of the insulated cover within the opening.

20. An insulated shipping container according to claim 19 wherein the ozone unit is also supported in place by contact of another side of the ozone unit with a pre-existing internal structure of and within the shipping container.

21. An insulated shipping container according to claim 20 wherein the pre-existing internal structure of and within the shipping container is a fan unit which in operation circulates air in the shipping container.

22. An insulated shipping container according to claim 20 wherein the pre-existing internal structure of and within the shipping container comprises one or more brackets.

23. An insulated shipping container according to claim 1 wherein the ozone unit is held in place without requiring mechanical fixing tools to install.
